(19) United States
(12) Patent Application Publication
(10) Pub. No.: US 2025/0021304 A1
(43) Pub. Date: Jan. 16, 2025

(54) COMPUTING-IN-MEMORY DEVICE AND NEURAL NETWORK DEVICE WITH COMPUTATION LAYER

(71) Applicant: UIF (University Industry Foundation), Yonsei University, Seoul (KR)

(72) Inventors: Seong Ook JUNG, Seoul (KR); Min Young JO, Seoul (KR); Young Kyu LEE, Seoul (KR)

(21) Appl. No.: 18/767,288

(22) Filed: Jul. 9, 2024

(30) Foreign Application Priority Data
Jul. 14, 2023 (KR) 10-2023-0091845

(51) Int. Cl. G06F 7/523; G06F 7/50

(52) U.S. Cl. CPC G06F 7/523; G06F 7/50

(57) ABSTRACT

Provided are a computing-in-memory (CIM) device and a neural network device with a computational layer. The CIM device includes an input conversion module configured to receive signed input data and convert the signed input data into unsigned input data, a CIM including multiple memory cells for separately storing weights and configured to receive the unsigned input data, perform a multiply-accumulate (MAC) operation between the unsigned input data and the stored weights, and output output data, and an output conversion module configured to output compensated output data by compensating the output data for a computational error. Accordingly, it is possible to efficiently perform neural network computation on a signed multibit input while minimizing an increase in size, computational complexity, and structural changes.

### CROSS-REFERENCE TO RELATED APPLICATION

This application claims priority to and the benefit of Korean Patent Application No. 2023-0091845, filed on Jul. 14, 2023, the disclosure of which is incorporated herein by reference in its entirety.

### BACKGROUND

### 1. Field of the Invention

The present disclosure relates to a computing-in-memory (CIM) device and a neural network device with the CIM device, and more particularly, a CIM device that performs a multiply-accumulate (MAC) operation on a signed multibit input and a neural network device with the CIM device.

### 2. Discussion of Related Art

According to the traditional von Neumann architecture, a processor and a memory are separated, and the processor takes the lead in performing operations on data stored in the memory, limiting improvement in the energy efficiency and computing speed of data access and transmission. Recent advances in artificial neural network technology involve a large amount of multiply-accumulate (MAC) operations between input data and weights in a deep neural network (DNN) or the like, requiring a technique to improve energy efficiency and computing speed.

For this reason, a computing-in-memory or in-memory computing (CIM) structure has been proposed to maximize efficiency by performing operations using a memory for storing data. In the CIM structure, the memory for storing data performs operations directly without transmitting data to a processor, overcoming the limitations of the traditional von Neumann architecture to perform operations at lower power and high speed.

However, most CIMs according to the related art can perform operations on single-bit inputs only, and even when CIMs perform operations on multibit inputs, the CIMs can perform operations on inputs of positive numbers only. CIMs are frequently used in artificial neural networks and the like, and in artificial neural networks according to the related art, unsigned activation functions that do not require signed expressions, such as a rectified linear unit (ReLU) function, are frequently used. However, lately, signed activation functions, such as leaky ReLU, Swish, and the like, have been increasingly used in artificial neural networks to handle complex tasks. Therefore, CIMs are required to receive signed inputs and perform MAC operations.

### SUMMARY OF THE INVENTION

The present disclosure is directed to providing a computing-in-memory (CIM) device for performing a multiply-accumulate (MAC) operation on a signed multibit input while preventing an increase in size.

The present disclosure is also directed to providing a neural network device for efficiently performing neural network computation on a signed multibit input while minimizing computational complexity and structural changes.

According to an aspect of the present disclosure, there is provided a CIM device including an input conversion module configured to receive signed input data and convert the signed input data into unsigned input data, a CIM including multiple memory cells for separately storing weights and configured to receive the unsigned input data, perform an MAC operation between the unsigned input data and the stored weights, and output output data, and an output conversion module configured to output compensated output data by compensating the output data for a computational error.

The input conversion module may receive the signed input data having multiple bits and convert the signed input data into the unsigned input data by inverting a bit value of a most significant bit (MSB).

The input conversion module may include at least one inverter configured to invert a bit value of an MSB of the signed input data.

The input conversion module may be implemented as a buffer circuit including multiple buffers configured to receive and buffer the signed input data, and an odd number of inverters may constitute a buffer which receives an MSB of the signed input data among the multiple buffers to invert a bit value of the MSB and output the inverted MSB value.

The output conversion module may compensate the output data which is acquired by performing the MAC operation between the unsigned input data and the weights in the CIM such that the compensated output data becomes a result of an MAC operation between the signed input data and the weights, and output the compensated output data.

The output conversion module may acquire the compensated output data by subtracting a compensation value, which is calculated as a product of a cumulative sum of the weights and a value of an MSB of the signed input data, from the output data.

The compensation value may be calculated and acquired in advance when the weights are acquired and stored.

According to another aspect of the present disclosure, there is provided a neural network device with a computational layer for performing neural network computation. The computational layer includes an input conversion buffer configured to receive and buffer signed input data and convert the signed input data into unsigned input data, a computational module configured to receive the unsigned input data, perform an MAC operation between the unsigned input data and stored weights, and output output data, and a conversion normalization module configured to compensate the output data for a computational error, batch-normalize the compensated output data, and output the batch-normalized output data.

According to another aspect of the present disclosure, there is provided a neural network device with a computational layer for performing neural network computation. The computational layer includes an input conversion module configured to receive signed input data and convert the signed input data into unsigned input data, a computational module configured to receive the unsigned input data, perform an MAC operation between the unsigned input data and stored weights, and output output data, and an output conversion module configured to compensate the output data for a computational error and output the compensated output data.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a diagram showing a schematic structure of a computing-in-memory (CIM) device according to the present disclosure;

FIG. 2 is a diagram illustrating an operation of an input module of FIG. 1;

FIG. 3 is a diagram showing an example of a schematic structure of a computational layer in a neural network model;

FIGS. 4 and 5 are diagrams showing examples of a schematic structure of a computational layer in a neural network model with a CIM according to the present disclosure; and

FIG. 6 is a diagram illustrating a conversion normalization module of FIG. 5.

### DETAILED DESCRIPTION OF EXEMPLARY EMBODIMENTS

Hereinafter, specific embodiments of the present disclosure will be described with reference to the drawings. The following detailed description is provided to help a comprehensive understanding of a method, a device, and/or a system described in this specification. However, this is only an example, and the present disclosure is not limited thereto.

In describing embodiments of the present disclosure, when it is determined that detailed description of well-known technologies related to the present invention may unnecessarily obscure the gist of embodiments, the detailed description will be omitted. Terms to be described below are terms defined in consideration of functions in the present invention, and may vary depending on the intention, practice, or the like of a user or operator. Therefore, the terms should be determined on the basis of the overall content of this specification. Terms used in the detailed description are only used to describe embodiments and should not be construed as limiting. Unless otherwise clearly specified, a singular expression includes the plural meaning. In this description, an expression such as “include” or “have” is intended to indicate certain features, numerals, steps, operations, elements, or some or combinations thereof, and should not be construed as excluding the presence or possibility of one or more other features, numerals, steps, operations, elements, or some or combinations thereof. Also, the terms “unit,” “device,” “module,” “block,” and the like described in this specification refer to units for processing at least one function or operation, which may be implemented by hardware, software, or a combination of hardware and software.

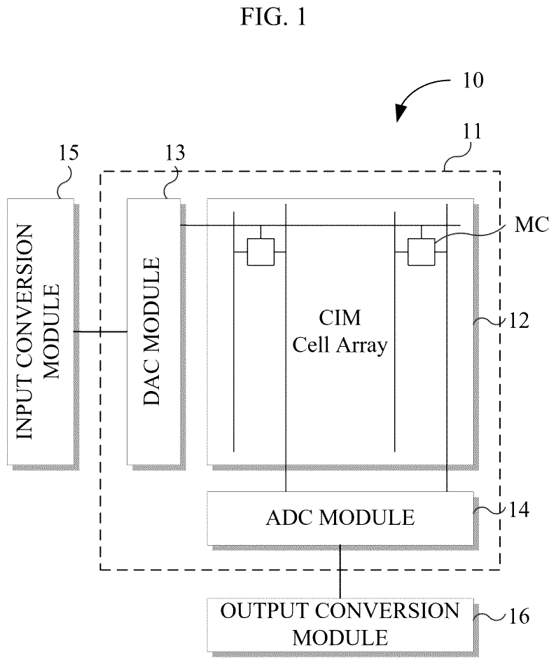

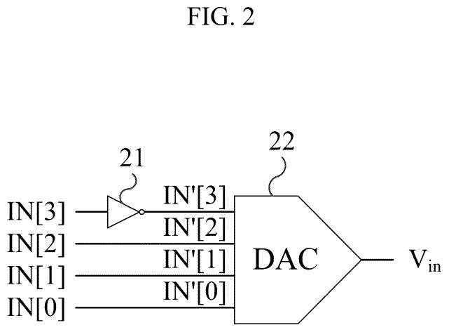

FIG. 1 is a diagram showing a schematic structure of a computing-in-memory (CIM) device according to the present disclosure, and FIG. 2 is a diagram illustrating an operation of an input module of FIG. 1.

Referring to FIG. 1, a CIM device 10 may include a CIM 11, an input conversion module 15, and an output conversion module 16, and the CIM 11 may include at least one CIM cell array 12, a digital-to-analog converter (DAC) module 13, and an analog-to-digital converter (ADC) module 14.

In the CIM 11, the DAC module 13 receives input data IN, which is digital data, converts the input data IN into an input voltage V_{IN}, and applies the converted input voltage to the CIM cell array 12. In other words, the DAC module 13 applies an analog signal having a voltage level according to a value of the input data IN to the CIM cell array 12. To this end, the DAC module 13 may include, for example, at least one DAC 22 for converting digital data into the analog input voltage V_{IN} as shown in FIG. 2. Here, the DAC module 13 may receive the input data IN having multiple bits and convert the input data IN into the input voltage V_{IN}.

However, in the CIM 11 of the present disclosure, the input data IN may not be directly applied to the DAC module 13 but may be input to the input conversion module 15, converted by the input conversion module 15, and then applied to the DAC module 13.

The input conversion module 15 may receive the signed multibit input data IN, convert the received signed multibit input data IN into unsigned multibit input data IN′ and apply the converted unsigned multibit input data IN′ to the DAC module 13. Then, the DAC module 13 converts the converted unsigned multibit input data IN′ into an input voltage V_{IN′} and applies the input voltage V_{IN′} to the CIM cell array 12.

Here, the input conversion module 15 may convert the signed multibit input data IN into the unsigned multibit input data IN′ by inverting a bit value of a most significant bit (MSB) in the signed multibit input data IN. As an example, when the input data IN is 4-bit signed multibit data IN [3:0], a range of a value expressed by the signed input data IN is [−8, 7], and when the input data IN is converted into unsigned input data IN′, a range of a value expressed by the unsigned input data IN′ is [0, 15]. The relationship between the signed input data IN and the unsigned input data IN′ may be as shown in Table 1.

TABLE 1

| IN | IN′ |
|---|---|
| −8(1000) | 0(0000) |
| −7(1000) | 1(0001) |
| . | . |
| . | . |
| . | . |
| 0(0000) | 8(1000) |
| 1(0001) | 9(1001) |
| . | . |
| . | . |
| . | . |
| 6(0110) | 14(1110) |
| 7(0111) | 15(1111) |

As shown in Table 1, when a bit value of the MSB of the signed input data IN is inverted, the signed input data IN may be converted into the unsigned input data IN′.

The input conversion module 15 may include at least one inverter 21 as shown in FIG. 2. Accordingly, when the 4-bit signed input data IN [3:0] is applied, the input conversion module 15 inverts an MSB IN [3] of the applied 4-bit signed input data IN [3:0] using the inverter 21 to convert the 4-bit signed input data IN [3:0] into unsigned input data IN′ [3:0]. Then, the unsigned input data IN′ [3:0] is input to the DAC module 13 such that the DAC module 13 may apply the input voltage V_{IN′} having a voltage level corresponding to a value of the unsigned input data IN′ [3:0] to the CIM cell array 12.

To facilitate understanding, the input conversion module 15 is shown to have the inverter 21 for inverting the MSB IN [3] of the applied signed input data IN [3:0]. However, even when only the CIM 11 is employed according to the related art, the input data IN is not directly applied to the DAC module 13 but is buffered in a buffer and the like and then applied to the DAC module 13 in practice. In general, a buffer is implemented as an even number of inverters connected in series. Therefore, in practice, the input conversion module 15 is not implemented as a separate circuit. Rather, one inverter may be removed from or added to a buffer for the MSB among multiple buffers for buffering the input data IN to make the number of inverters connected in series odd such that the input conversion module 15 is very easily implemented. In this case, it is possible to prevent an increase in the size of the CIM device 10.

The CIM cell array 12 includes multiple memory cells MC each of which stores a weight. In the CIM cell array 12, a multiply operation is performed between the unsigned input data IN′, which is converted into the input voltage V_{IN′} by the DAC module 13 and applied, and each of multiple stored weights W, and a multiply-accumulate (MAC) voltage V_{MAC} corresponding to an MAC operation result, which is obtained by accumulating a product of the unsigned input data IN′ and each of the multiple weights W, is generated and applied to the ADC module 14.

As described above, according to the present disclosure, the signed multibit input data IN is converted into the unsigned multibit input data IN′ by the input conversion module 15, converted into the input voltage V_{IN′}, and then applied to the CIM cell array 12. Accordingly, from the perspective of the CIM cell array 12, this may be viewed as performing an MAC operation on the unsigned multibit input data IN′, which is substantially the same as in a CIM according to the related art. Therefore, the CIM cell array 12 may employ, without any change, a CIM cell array having a structure for performing an MAC operation on the unsigned multibit input data IN′ according to the related art.

In the CIM cell array 12, the multiple memory cells MC may be implemented as, for example, 6 transistor (6T) static random-access memories (SRAMs) and the like. According to the related art, a CIM cell array performs an analog operation in which each of the multiple memory cells MC transmits, to the output conversion module 16, a current according to a value obtained by applying a weight W to the applied input data IN. Accordingly, the multiple memory cells MC are very vulnerable to process-voltage-temperature (PVT) variations. To solve this problem, each of the memory cells MC may be implemented as a 10T SRAM, an 8T SRAM+one capacitor (1C), and the like rather than a 6T SRAM.

Also, the CIM cell array 12 may maintain the memory cell structure and further include multiple local computing cells (LCCs) to perform analog MAC operations robustly against PVT variations. In this case, in the CIM cell array 12, a region in which the multiple memory cells ML are disposed is referred to as a memory cell array MCA, and a region in which the multiple LCCs are disposed is referred to as an LCC array.

In the CIM cell array 12 with the LCC array LCCA, the memory cells MC simply store weights and perform no multiply operation because the input voltage V_{IN′} is not applied. Instead, each of the multiple LCCs of the LCC array LCCA receives the input voltage V_{IN′} and reads a weight W stored in a memory cell MC. Then, each of the multiple LCCs performs a multiply operation on the received input data IN′ and the read weight W, and multiply operation results of the multiple LCCs are accumulated on an accumulation line to acquire the MAC voltage V_{MAC} corresponding to the MAC operation results. In other words, since the CIM cell array 12 separately includes the memory cells MC for storing the weights W and LCCs for performing an MAC operation, it is possible to perform MAC operations robustly against PVT variations.

In other words, in the present disclosure, any CIM cell array to which the unsigned multibit input data IN′ is applicable can be employed as the CIM cell array 12 regardless of its structure or configuration. Although the single CIM cell array 12 is shown as a simple example, the CIM 11 may include multiple CIM cell arrays 12.

The ADC module 14 converts the MAC voltage V_{MAC}, which represents a result of MAC operations performed in the memory cells MC of the CIM cell arrays 12, into digital data to output output data OUT′. As an example, the ADC module 14 may include at least one ADC for receiving the MAC voltage V_{MAC} which is an analog voltage and converting the MAC voltage V_{MAC} into the output data OUT′ which is digital data.

The output conversion module 16 receives the output data OUT′ acquired from the ADC module 14 and compensates the output data OUT′ for an error, which is generated in the output data OUT′ during a process in which the input conversion module 15 converts the signed input data IN into the unsigned input data IN′, to output compensated output data OUT.

As described above, according to the present disclosure, the input conversion module 15 converts the signed input data IN into the unsigned input data IN′ by inverting the value of the MSB of the signed input data IN, and then the DAC module 13 applies the input voltage V_{IN′} obtained by converting the unsigned input data IN′ into an analog voltage to the CIM cell array 12. Therefore, the CIM cell array 12 performs an MAC operation between the unsigned input data IN′ rather than the signed input data IN and the weights W. For this reason, the output data OUT′ which is obtained by converting the MAC voltage V_{MAC} into digital data without any change through the ADC module 14 is not output as an MAC operation result between the signed input data IN and the weights W. In other words, an error occurs.

For the output conversion module 16 to compensate for the error, it is necessary to check the error between the signed input data IN and the unsigned input data IN′. As described above in the example, when the signed input data IN is 4-bit data IN [3:0], a value of the signed input data IN may be represented as shown in Equation 1.

$$IN [ 3 : 0 ] = - 8 * IN [ 3 ] + 4 * IN [ 2 ] + 2 * IN [ 1 ] + 1 * IN [ 0 ] \qquad [ Equation 1 ]$$

Also, the unsigned input data IN′ obtained by inverting the MSB of the signed input data IN may be represented as shown in Equation 2.

$${IN}^{′} [ 3 : 0 ] = - 8 * IN [ 3 ] + 4 * IN [ 2 ] + 2 * IN [ 1 ] + 1 * IN [ 0 ] + 8 \qquad [ Equation 2 ]$$

In other words, the error between the signed input data IN and the unsigned input data IN′ is 8, which is equal to a value obtained by adding values of cases where the MSB (here, IN [3]) of the unsigned input data IN′ is 1.

Therefore, from Equations 1 and 2, the output data OUT′ which is an MAC operation result between the unsigned input data IN′ [3:0] and the weights W[3:0] may be represented as shown in Equation 3.

$$\begin{matrix}{OUT}^{′} = \sum W [ 3 : 0 ] * ( {IN}^{′} [ 3 : 0 ] ) \\ = \sum W [ 3 : 0 ] * ( IN [ 3 : 0 ] + 8 ) \\ = \sum W [ 3 : 0 ] * ( IN [ 3 : 0 ] + 8 * \sum W [ 3 : 0 ] )\end{matrix} \qquad [ Equation 3 ]$$

However, the compensated output data OUT which is an MAC operation result between the signed input data IN [3:0] and the 4-bit weights W[3:0] is calculated as shown in Equation 4 according to Equation 1.

$$OUT = \sum W [ 3 : 0 ] * IN [ 3 : 0 ] \qquad [ Equation 4 ]$$

Comparing Equations 3 and 4, a difference between the output data OUT′ and the compensated output data OUT is equal to a product of a cumulative sum ΣW[3:0] of the weights W[3:0] and a value (8) of an MSB of the unsigned input data IN′. Therefore, the output conversion module 16 may receive the output data OUT′ of Equation 3 and compensate the output data OUT′ according to Equation 5 to obtain the compensated output data OUT of Equation 4.

$$\begin{matrix}OUT = {OUT}^{′} - 8 * \sum W [ 3 : 0 ] \\ = \sum W [ 3 : 0 ] * ( IN [ 3 : 0 ] ) - 8 * \sum W [ 3 : 0 ]\end{matrix}$$

In other words, the output conversion module 16 may acquire the compensated output data OUT by subtracting the product of the cumulative sum 2 W [3:0] of the weights W[3:0] and the value of the MSB of the unsigned input data IN′, which is a compensation value, from the output data OUT′ output from the ADC module 14.

As a result, in the CIM device 10 according to the present disclosure, the input conversion module 15 converts the signed input data IN into the unsigned input data IN′ and applies the unsigned input data IN′ to the CIM 11, the CIM 11 performs an MAC operation between the converted unsigned input data IN′ and the weights W to output the output data OUT′, and the output conversion module 16 compensates for the error included in the output data OUT′ by subtracting the compensation value (IN [MSB]*ΣW) from the output data OUT′ to output the compensated output data OUT. Therefore, even when the CIM 11 is configured to perform an MAC operation between the unsigned multibit input data IN′ and the weights W according to the related art, the input conversion module 15 and the output conversion module 16 perform conversion to output the same result as if an MAC operation between the signed input data IN and the weights W were performed.

It is necessary to acquire the compensation value (IN [MSB]*ΣW) in advance such that the output conversion module 16 may compensate for the output data OUT′ according to Equation 5. In the compensation value (IN [MSB]*ΣW), the value (IN [MSB]) of the MSB of the input data IN is determined in advance according to the number of bits of the input data IN, and thus it is necessary to acquire the cumulative sum (ΣW) of the weights W in advance.

However, even according to the related art, the CIM 11 is mainly used to implement an artificial neural network model as hardware, particularly, to implement at least one computational layer in a convolutional neural network model. In the memory cells MC of the CIM cell array 12, the weights W of computational layers which are acquired through training are stored. Therefore, values of the weights W stored in the memory cells MC are determined during the training, and when the determined weights W are stored in the memory cell MC of the CIM cell array 12, the output conversion module 16 receives the compensation value (IN [MSB]*ΣW), which is in accordance with the cumulative sum ΣW of the precalculated weights W, from a training device and stores the compensation value (IN [MSB]*ΣW) to readily compensate for the output data OUT′. In other words, the compensation value (IN [MSB]*ΣW) may be calculated by software and acquired in advance.

Although not shown in the drawings for convenience of description, the CIM 11 may further include a row decoder (not shown) for selecting in row units multiple memory cells MC arranged in the CIM cell array 12 according to a row address among addresses, which are applied with the input data IN or the weights W, and a column decoder (not shown) for selecting in column units multiple memory cells MC arranged in the CIM cell array 12 according to a column address among the applied addresses. Depending on a CIM structure, other components may be included in addition to the row decoder and the column decoder.

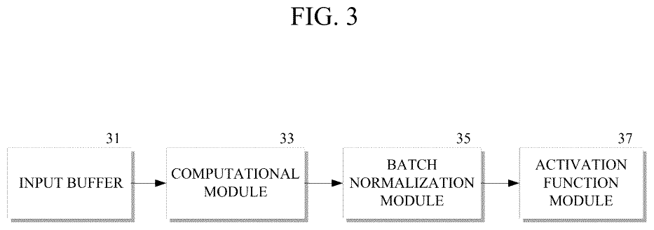

FIG. 3 is a diagram showing an example of a schematic structure of a computational layer in a neural network model.

A neural network model may include multiple computational layers each for performing neural network computation and may be implemented as software or hardware. Here, a neural network model is assumed to be implemented as hardware.

As shown in FIG. 3, a computational layer of the neural network model may include an input buffer 31, a computational module 33, a batch normalization module 35, and an activation function module 37. The input buffer 31 receives an input of the neural network model or an output of a preceding computational layer as input data IN and buffers the input data IN. The input buffer 31 may include multiple buffers and buffer the input data IN to transmit the input data IN to the computational module 33.

In the computational module 33, multiple weights W which are determined in advance through training are stored. When the input data IN is applied from the input buffer 31, the computational module 33 performs an MAC operation between the applied input data IN and the stored weights W and outputs output data OUT which is an MAC operation result. The computational module 33 may be implemented as a CIM for performing an MAC operation between the input data IN and the weights W. Here, the input data IN may be multibit input data. However, an MAC operation is not performed on the input data IN having multiple signed bits by the CIM according to the related art, and thus the input data IN having multiple unsigned bits may be input to the input buffer 31.

The batch normalization module 35 receives the output data OUT and performs batch normalization. Batch normalization is used in a neural network model to improve learning efficiency by normalizing distribution of output data or input data of each computation layer. When batch normalization is performed during learning of a neural network model, a learning rate increases, a bias caused by an initial value is reduced, and overfitting can be prevented.

The batch normalization module 35 may perform batch normalization BN according to Equation 6 such that output data OUT output from computational modules 33 of computational layers may have uniform average and distribution.

$$BN = γ ( \frac{y - μ}{σ} ) + β = \frac{γ}{σ} ( y + β \frac{σ}{γ} - μ ) = A ( y + B ) \qquad [ Equation 6 ]$$

Here, y is output data (y=OUT), γ is a scale parameter for batch normalization, and β is a shift parameter which is acquired with the weights W during learning of a neural network model. Also, A and B are respectively a weight normalization parameter and an addition normalization parameter for simplifying and performing batch normalization. A equals γ/σ, and B equals β(γ/σ)−μ.

In the case of implementing

$$γ ( \frac{y - μ}{σ} ) + β$$

the batch normalization formula of Equation 6 as hardware without any change, all elementary arithmetic operations of addition, subtraction, multiplication, and division are included, which increases hardware complexity. Accordingly, when the weight normalization parameter A and the addition normalization parameter B are calculated in advance by software to change the batch normalization formula to A (y+B), the batch normalization can be performed by an adder and a multiplier, which reduces hardware complexity. In other words, the batch normalization module 35 may include a multiplier and an adder.

The batch normalization module 35 may be disposed between the input buffer 31 and the computational module 33 to normalize distribution of the input data IN applied from the input buffer 31 and then transmit the batch-normalized input data to the computational module 33 or may be disposed behind the activation function module 37. However, in the present disclosure, the batch normalization module 35 is assumed to be disposed between the computational module 33 and the activation function module 37 to perform batch normalization on output data of the computational module 33.

The activation function module 37 performs an operation according to an activation function which is applied when the neural network model is designed, and outputs or transmits a result of the activation function operation to a next computational layer. As described above, unsigned activation functions that do not require signed expressions, such as a rectified linear unit (ReLU) function, have been frequently used in artificial neural networks according to the related art, whereas signed activation functions, such as leaky ReLU, Swish, and the like, are frequently being used in activation function modules lately.

Therefore, it is necessary to configure the computational module 33 to perform an MAC operation on the signed input data IN such that the computational layer may utilize a signed activation function. Accordingly, in a neural network model of the present disclosure, a computational module may be implemented using the CIM device 10 described above with reference to FIGS. 1 and 2.

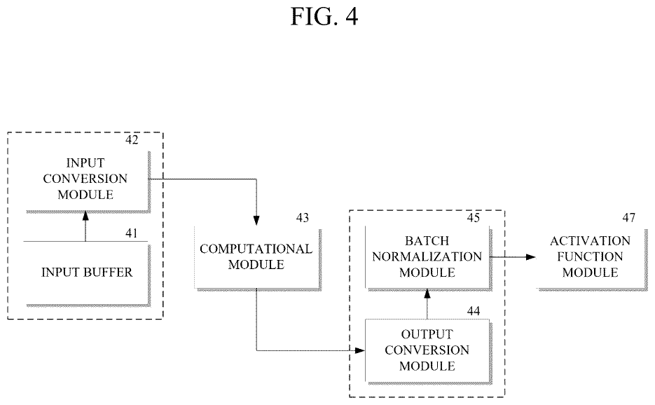

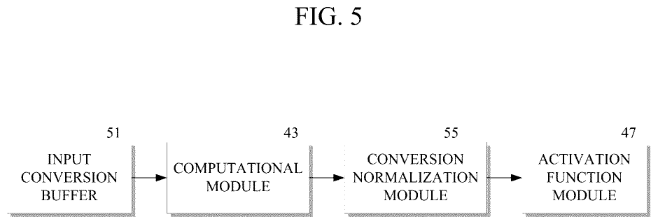

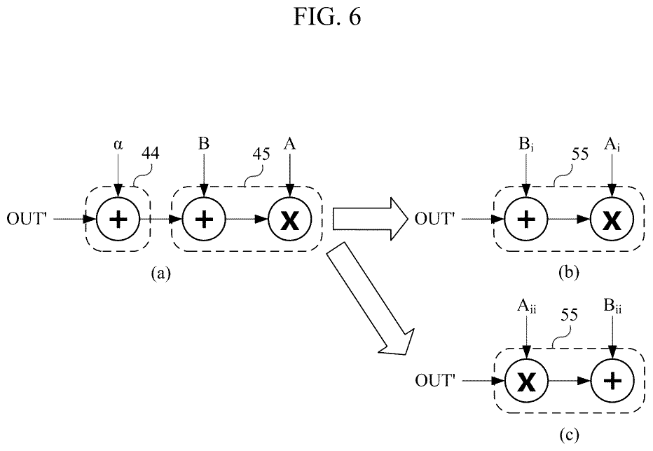

FIGS. 4 and 5 are diagrams showing examples of a schematic structure of a computational layer in a neural network model with a CIM according to the present disclosure, and FIG. 6 is a diagram illustrating a conversion normalization module of FIG. 5.

Referring to FIG. 4, in a neural network model according to the present disclosure, a computational layer includes an input buffer 41, a computational module 43, a batch normalization module 45, and an activation function module 47 like the computational layer of FIG. 3. The input buffer 41, the computational module 43, the batch normalization module 45, and the activation function module 47 may perform the same operations as the input buffer 31, the computational module 33, the batch normalization module 35, and the activation function module 37 of the computational layer shown in FIG. 3. In other words, the computational layer of the present disclosure shown in FIG. 4 basically has a similar configuration to the computational layer of FIG. 3. Therefore, the computational module 43 may be implemented as a CIM for receiving unsigned multibit input data, performing an MAC operation between the input data and stored weights, and outputting output data. In other words, the computational module 43 may be implemented as the CIM 11 of FIG. 1.

In the present disclosure, as shown in FIG. 4, the computational layer further includes an input conversion module 42 between the input buffer 41 and the computational module 43 and an output conversion module 44 between the computational module 43 and the batch normalization module 45. The input conversion module 42 and the output conversion module 44 of FIG. 4 may be elements that perform the same operations as the input conversion module 15 and the output conversion module 16 of FIG. 1, respectively.

In other words, when signed input data IN having multiple signed bits is applied through the input buffer 41, the input conversion module 42 converts the applied signed input data IN into unsigned input data IN′ having multiple unsigned bits and transmits the unsigned input data IN′ to the computational module 43. The output conversion module 44 receives output data OUT′ output from the computational module 43 implemented as the CIM 11, acquires compensated output data OUT by compensating the output data OUT′ using a compensation value, and transmits the acquired compensated output data OUT to the batch normalization module 45.

As a result, according to the computational layer of the present disclosure shown in FIG. 4, the computational module 43 in the computational layer which performs neural network computation on unsigned multibit input data according to the related art is replaced with the CIM device 10 shown in FIG. 1 such that neural network computation can be performed on the signed multibit input data IN. Here, in the CIM device 10 shown in FIG. 1, the CIM 11 is implemented in the same way as the CIM that is provided in the computational module 33 according to the related art to perform an MAC operation between unsigned multibit input data and weights. Therefore, the computational layer according to the present disclosure which is obtained by simply adding the input conversion module 42 and the output conversion module 44 to the operational layer according to the related art can perform neural network computation on the signed multibit input data IN.

In addition, as shown in FIGS. 1 and 2, the input conversion module 15 may include at least one inverter 21 for inverting an MSB (IN [MSB]) of the signed input data IN. Therefore, the input conversion module 42 of FIG. 4 may be simply implemented by removing one inverter from a buffer for buffering the MSB (IN [MSB]) of the input data IN among multiple buffers provided in the input buffer 41. In other words, the input conversion module 42 is not implemented as a separate circuit but may be implemented by simply changing a structure of the input buffer 41. When the input buffer 41 is implemented to perform an operation of the input conversion module 42 together, the input buffer 41 may be referred to as an input conversion buffer 51 as shown in FIG. 5.

Meanwhile, like the output conversion module 16 of FIG. 1, the output conversion module 44 acquires the compensated output data OUT by subtracting a compensation value (IN [MSB]*ΣW) from the output data OUT′ output from the computational module 43. The compensation value (IN [MSB]*ΣW) may be calculated by software and acquired in advance. Therefore, the output conversion module 44 may be simply implemented as an adder for subtracting the compensation value (IN [MSB]*ΣW) from the output data OUT′.

As described above, the batch normalization module 45 may calculate the weight normalization parameter A and the addition normalization parameter B for the output data OUT (equal to y) output from the computational module 43 in advance using software to simply perform batch normalization such as A (y+B). In this case, the batch normalization module 45 may be implemented using an adder and a multiplier. Therefore, when the compensation value (IN [MSB]*ΣW) is simply indicated by α, operations performed by the output conversion module 44 and the batch normalization module 45 may be implemented as shown in (a) of FIG. 6 using two adders for separately receiving and adding the addition normalization parameter B and the compensation value α and one multiplier for multiplying the sum by the weight normalization parameter A.

However, as described above, the weight normalization parameter A, the addition normalization parameter B, and the compensation value α are calculated by software in advance and applied. Accordingly, an overall operation performed in the output conversion module 44 and the batch normalization module 45 may be as shown in Equation 7 or 8.

$$BN = \frac{γ}{σ} ( y + β \frac{σ}{γ} - ( μ + α ) ) = {A}_{i} ( y + {B}_{i} ) \qquad [ Equation 7 ]$$

$$BN == \frac{γ}{σ} y - γ \frac{μ + α}{σ} + β = {A}_{ii} y + {B}_{ii} \qquad [ Equation 8 ]$$

In other words, operations of the output conversion module 44 and the batch normalization module 45 are integrated into Equation 7 or 8 of compensated weight normalization parameters Aᵢ and Aᵢᵢ and compensated addition normalization parameters Bᵢ and Bᵢᵢ reflecting the compensation value α. Therefore, the output conversion module 44 and the batch normalization module 45 may be integrated into a conversion normalization module 55 as shown in FIG. 5.

The conversion normalization module 55 may include one adder for receiving and adding the compensated addition normalization parameters Bᵢ and Bᵢᵢ and one multiplier for receiving and weighting the compensated weight parameters Aᵢ and Aᵢᵢ according to Equations 7 and 8 as shown in (b) and (c) of FIG. 6. This is the same configuration as that of the batch normalization modules 35 and 45 according to the related art. Even when the output conversion module 44 is combined with the batch normalization module 35 or 45 into the conversion normalization module 55, the hardware configuration of a computational layer may not change.

As a result, the present disclosure can provide a CIM device for performing an MAC operation on signed input data with a minimal change in hardware and no increase in size, and a neural network device with the CIM device.

In the exemplary embodiment shown in the drawings, each element may have a different function and capability than described above, and elements other than those described above may be additionally included. Also, according to an exemplary embodiment, each element may be implemented using one or more physically separated devices or by one or more processors or a combination of one or more processors and software, and unlike the examples shown in the drawings, may not be clearly divided in terms of specific operations.

The CIM device shown in FIG. 1 and the neural network devices shown in FIGS. 4 and 5 may be implemented by hardware, firmware, software, or a combination thereof in a logic circuit or implemented using a general-use or specific-purpose computer. The device may be implemented using a hardwired device, a field programmable gate array (FPGA), an application specific integrated circuit (ASIC), and the like. Also, the device may be implemented as a system on chip (SoC) including one or more processors and a controller.

In addition, the CIM device and the neural network device may be installed in the form of software, hardware, or a combination thereof on a computing device or server in which hardware elements are provided. The computing device or server may be various devices including all or some of a communication device, such as a communication modem, for communicating with various types of equipment or wired or wireless communication networks, a memory for storing data for executing a program, a microprocessor for executing the program for computation and instructing, and the like.

The CIM device and the neural network with the CIM device according to the present disclosure can perform an MAC operation on a signed multibit input while preventing an increase in size and can efficiently perform neural network computation on a signed multibit input while minimizing computational complexity and structural changes.

Although the present invention has been described above with reference to the exemplary embodiments, those of ordinary skill in the art should understand that various modifications and other equivalent embodiments can be made from the embodiments. Therefore, the technical scope of the present invention should be determined from the technical spirit of the following claims.

What is claimed is:

1. A computing-in-memory (CIM) device, the CIM device comprising:
an input conversion module configured to receive signed input data and convert the signed input data into unsigned input data;
a CIM including multiple memory cells for separately storing weights and configured to receive the unsigned input data, perform a multiply-accumulate (MAC) operation between the unsigned input data and the stored weights, and output output data; and
an output conversion module configured to output compensated output data by compensating the output data for a computational error.

2. The CIM device of claim 1, wherein the input conversion module receives the signed input data having multiple bits and converts the signed input data into the unsigned input data by inverting a bit value of a most significant bit (MSB).

3. The CIM device of claim 1, wherein the input conversion module includes at least one inverter configured to invert a bit value of a most significant bit (MSB) of the signed input data.

4. The CIM device of claim 1, wherein the input conversion module is implemented as a buffer circuit including multiple buffers configured to receive and buffer the signed input data, and
an odd number of inverters constitute a buffer which receives a most significant bit (MSB) of the signed input data among the multiple buffers to invert a bit value of the MSB and output the inverted MSB value.

5. The CIM device of claim 1, wherein the output conversion module compensates the output data which is acquired by performing the MAC operation between the unsigned input data and the weights in the CIM such that the compensated output data becomes a result of an MAC operation between the signed input data and the weights, and outputs the compensated output data.

6. The CIM device of claim 1, wherein the output conversion module acquires the compensated output data by subtracting a compensation value, which is calculated as a product of a cumulative sum of the weights and a value of a most significant bit (MSB) of the signed input data, from the output data.

7. The CIM device of claim 6, wherein the compensation value is calculated and acquired in advance when the weights are acquired and stored.

8. A neural network device with a computational layer for performing neural network computation, wherein the computational layer comprises:
an input conversion buffer configured to receive and buffer signed input data and convert the signed input data into unsigned input data;
a computational module configured to receive the unsigned input data, perform a multiply-accumulate (MAC) operation between the unsigned input data and stored weights, and output output data; and
a conversion normalization module configured to compensate the output data for a computational error, batch-normalize the compensated output data, and output the batch-normalized output data.

9. The neural network device of claim 8, wherein the input conversion buffer receives the signed input data having multiple bits and converts the signed input data into the unsigned input data by inverting a bit value of a most significant bit (MSB).

10. The neural network device of claim 8, wherein the input conversion buffer includes multiple buffers configured to receive and buffer the signed input data, and
an odd number of inverters constitute a buffer which receives a most significant bit (MSB) of the signed input data among the multiple buffers to invert a bit value of the MSB of the signed input data.

11. The neural network device of claim 8, wherein the conversion normalization module compensates the output data, which is acquired by performing the MAC operation between the unsigned input data and the weights in the computational module, using a compensation value such that the compensated output data becomes a result of an MAC operation between the signed input data and the weights.

12. The neural network device of claim 8, wherein the conversion normalization module comprises:
an adder configured to add a compensated addition normalization parameter to the output data between the compensated addition normalization parameter and a compensated weight normalization parameter obtained by reflecting a compensation value, which is calculated as a product of a cumulative sum of the weights and a value of a most significant bit (MSB) of the signed input data, to an addition normalization parameter and a weight normalization parameter which are acquired for batch normalization; and
a multiplier configured to multiply an output of the adder by the compensated weight normalization parameter.

13. The neural network device of claim 8, wherein the conversion normalization module comprises:
a multiplier configured to multiply a compensated weight normalization parameter by the output data between a compensated addition normalization parameter and the compensated weight normalization parameter obtained by reflecting a compensation value, which is calculated as a product of a cumulative sum of the weights and a value of a most significant bit (MSB) of the signed input data, to an addition normalization parameter and a weight normalization parameter which are acquired for batch normalization; and
an adder configured to add the compensated addition normalization parameter to an output of the multiplier.

14. The neural network device of claim 11, wherein the compensation value is calculated and acquired in advance when the weights are acquired and stored.

15. A neural network device with a computational layer for performing neural network computation, wherein the computational layer comprises:
an input conversion module configured to receive signed input data and convert the signed input data into unsigned input data;
a computational module configured to receive the unsigned input data, perform a multiply-accumulate (MAC) operation between the unsigned input data and stored weights, and output output data; and
an output conversion module configured to compensate the output data for a computational error and output the compensated output data.

16. The neural network device of claim 15, wherein the input conversion module receives the signed input data having multiple bits and converts the signed input data into the unsigned input data by inverting a bit value of a most significant bit (MSB).

17. The neural network device of claim 15, wherein the output conversion module compensates the output data, which is acquired by performing the MAC operation between the unsigned input data and the weights in the computational module, such that the compensated output data becomes a result of an MAC operation between the signed input data and the weights, and outputs the compensated output data.

18. The neural network device of claim 15, wherein the output conversion module acquires the compensated output data by subtracting a compensation value, which is calculated as a product of a cumulative sum of the weights and a value of a most significant bit (MSB) of the signed input data, from the output data.

19. The neural network device of claim 18, wherein the compensation value is calculated and acquired in advance when the weights are acquired and stored.
